(19) United States
(12) Patent Application Publication
(10) Pub. No.: US 2006/0157085 A1
(43) Pub. Date: Jul. 20, 2006

(54) SCREENING NEST, METHOD OF SCREENING WIRING LAYERS IN A MULTI-LAYER CERAMIC AND CLEANING THE SCREENING MASK AND MASK CLEANING STATION

(75) Inventors: John F. Harmuth, Pleasant Valley, NY (US); Lester W. Herron, New Platz, NY (US); Krystyna W. Semkow, Poughquag, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK (US)

(21) Appl. No.: 10/905,712

(22) Filed: Jan. 18, 2005

(51) Int. Cl. B08B 3/00; B05D 5/00

(52) U.S. Cl. 134/26; 134/34; 134/94.1; 134/198; 427/282; 118/621

(57) ABSTRACT

A screening nest, method of screening green sheets and cleaning the mask and a mask cleaning station. The screening nest includes an electromagnet that clamps the mask to a green sheet on the nest during screening. The mask may be electromagnetically dampened during application and removal. The cleaning station electromagnetically dampens the mask during cleaning and especially during rinsing and drying.

### BACKGROUND OF THE INVENTION

1. Field of the Invention

The present invention is related to integrated circuit (IC) chip packaging and more particularly to a screening station for screening paste onto a ceramic green sheet and to a station for cleaning the screening mask between screenings.

2. Background Description

Performance and signal density demands in semiconductor chip packaging are forcing Single Chip Modules (SCMs) and, especially, Multi-Chip Modules (MCMs) to become more and more complex. Ceramic module signal density is being increased both by increasing the number of ceramic wiring layers (with one wiring or power layer on each ceramic layer) and by printing narrower and narrower lines on finer and finer pitch. Wiring is printed on an uncured ceramic substrate layer (green sheet), e.g., using a metal mask and screening a paste (molybdenum paste, copper paste, copper/glass paste) pattern onto green sheets to define wiring lines and spaces. Such patterned green sheets are stacked, laminated and sintered to produce a Multi-Layered Ceramic (MLC) product that may include one MLC substrate or, several individual MLC substrates (also known as “ups”) that are separated (e.g., sawn) into individual final products. Misprinted lines or spaces on a single green sheet may ruin the entire product.

Typically, a green sheet is placed on a nest, with the green sheet then located under the mask. The nest is elevated to raise the green sheet to the mask, tensioning the mask and, hopefully, eliminating any gap between the green sheet and the mask during screening. Unfortunately, a poorly (over or under) tensioned mask distorts the screened pattern. If the mask is not flush (under-tensioned) against the green sheet, the paste may “bleed out” around lines into the gap between the mask and the green sheet. If the mask is over-tensioned, it may stretch out of shape. Also, even if the mask is firmly mated to the center of the green sheet, the mask at its edges may bow upward and lift away from the green sheet.

Further, since with each screening some paste residue remains behind on the mask, similar to paint remaining on a stencil after stenciling. So, to maintain image quality, each mask must be periodically cleaned, e.g., after each screening. For example, the mask may be sprayed with a Tetra-Methyl Ammonium Hydroxide (TMAH) solution, high pressure rinsed with water and then, dried with pressurized air. Each cleaning causes mask wear, such that the mask may “fatigue” from mask vibration and suffer prematurely broken tabs. While broken tabs may be immediately noticeable, mask fatigue may be more subtle, distorting subsequently printed shapes and that distortion may go unnoticed until well after sintering. Distorted/defective wiring layers degrade module yield and defective/distorted masks must be replaced. Both reduced product yield and frequently replacing masks increases module manufacturing costs and effort.

Thus, there is a need for extending the life on module wiring masks and improving the image quality of wiring printed on ceramic green sheets.

### SUMMARY OF THE INVENTION

It is a purpose of the invention to improve ceramic module wiring quality;

It is another purpose of the invention to reduce green sheet screening defects;

It is yet another purpose of the invention to extend screening mask life.

The present invention relates to a screening nest, method of screening green sheets and cleaning the mask and a mask cleaning station. The screening nest includes an electromagnet that clamps the mask to a green sheet on the nest during screening. The mask may be electromagnetically dampened during application and removal. The cleaning station electromagnetically dampens the mask during cleaning and especially during rinsing and drying.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A shows an example of a preferred embodiment mask and nest arrangement according to the present invention;

FIG. 1B shows a more detailed assembly view of a preferred embodiment nest for a green sheet with a single up;

FIG. 1C shows an assembly view of a multiple up location preferred embodiment nest;

FIGS. 2A-C show an example of tensioning a mask against a green sheet located on a nest according to a preferred embodiment the present invention;

FIGS. 3A-C show a comparison of a prior art nest with a mechanical dampener disposed on a mask with two alternate preferred embodiment mechanical dampened nests according to the present invention;

FIG. 4 shows an example of a mask cleaning station according to a preferred embodiment of the present invention.

### DESCRIPTION OF PREFERRED EMBODIMENTS

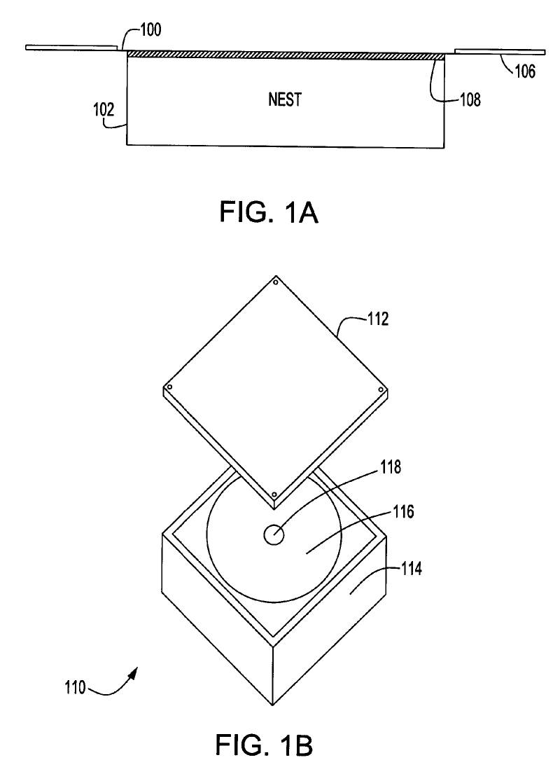

FIG. 1A shows an example of a preferred embodiment mask 100 and nest 102 arrangement according to the present invention. Primarily, the mask 100 is of a magnetic or ferromagnetic material (e.g., nickel) and the nest 102 includes a switchable magnetic field, e.g., one or more electromagnet embedded in the nest 102. As is typical of metal masks used in printing green sheets, the preferred mask 100 is an electroformed metal mask of a patterned copper core electroplated with nickel and held in any suitable frame 106, preferably of non-magnetic material. A green sheet 108 is located on the upper surface of the nest 102. The copper core does not exhibit magnetic properties while the ferromagnetic plating material (nickel) can be temporarily magnetized in a magnetic or an electromagnetic field. Thus, by activating the electromagnet the mask 100 is magnetically clamped to the green sheet 108 during screening for a high quality image; and thereafter, quickly and cleanly magnetically separated when screening is completed to maintain image quality.

FIG. 1B shows a more detailed assembly view of a preferred embodiment nest 110 for a green sheet with a single up. In this example, a nest top 112 has been removed from a nest bottom assembly 114, exposing the electromagnet 116. In this example, the electromagnet 116 is embedded in epoxy and patterned to match the single up configuration. Also in this example, the nest bottom assembly 114 includes an electromagnetic dampener 118, e.g. located in the center and buried in epoxy. Thus, electromagnet 116 clamps the mask to the green sheet during screening and the electromagnetic dampener 118 dampens mask vibrations when the nest 110 is raised and, optionally, when the nest is lowered after screening is complete.

FIG. 1C shows an assembly view of a multiple-up location preferred embodiment nest 120. In this example, the nest top 122 includes four up locations 124 or stations for screening multiple patterns simultaneously. So, for example, a 44 mm final product size may be made as a 4 up 185 mm green sheet. In yet another example, (not shown) the same final product size may be made as a 9 up configuration in a larger 215 mm green sheet. Since after lamination and sintering, the ups are cut into individual ups of the final size (44 mm), the metal mask has a solid kerf between the locations 124, i.e., the printed pattern is blank between the locations 124. So, in this example the nest bottom assembly 126 includes an electromagnet 128 configured for four locations, also embedded in epoxy. Thus, for a multiple up nest, the electromagnet 128 is patterned to match the particular ups configuration to better seal the mask during the screening process, forcing a gasket around each up, i.e., in the kerf locations. Also in this example, a single electromagnetic dampener 118 is located in the center and buried in epoxy.

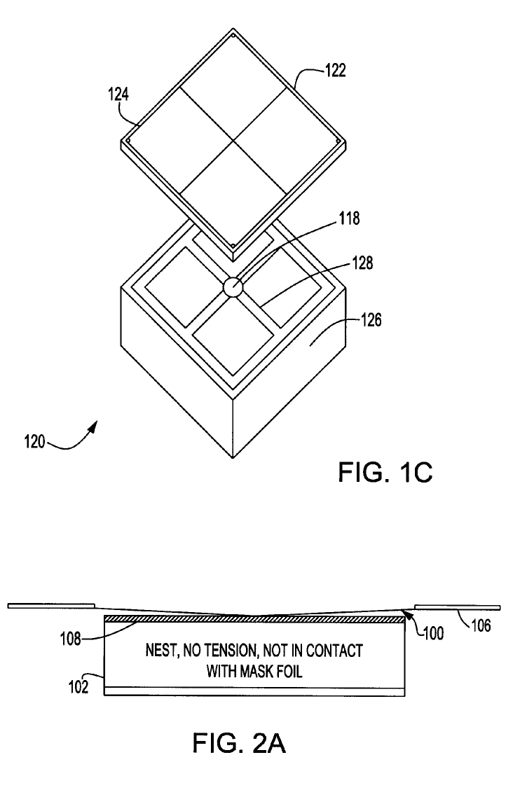

FIGS. 2A-C show an example of steps in tensioning a mask (e.g., 100 of FIG. 1A) against a green sheet 108 located on a nest 102 according to a preferred embodiment the present invention. First in FIG. 2A, the mask 100 is positioned such that the nest 102 holding the green sheet 108 is located beneath the mask 100. Then, in FIG. 2B, the nest 102 is elevated to bring the mask 100 in contact with the green sheet 108 on the nest 102. Thus, although the mask may be in contact with the green sheet 108, the electromagnet has not been switched on or activated and so, the mask is not taught as indicated by the non-linear, rippling in the mask 100. However, since the preferred mask 100 is a ferromagnetic material it acts as a magnet when it is in a magnetic field, i.e., by activating the electromagnet, e.g., 116 in FIG. 1B. So as shown in FIG. 2C, once the electromagnet is switched on or activated, the mask 100 becomes taught and firmly holds in place flush against the green sheet 108 at the surface of the nest 102. Thus, under the magnetic field the mask 100 conforms to and mates with the green sheet surface to prevent paste bleed out. Also, since the mask 100 is not being stretched to tension it, mask deformation is reduced to minimize pattern shifts otherwise occurring during screening. The electromagnetic field may be modulated to assist mask application/removal by selectively attracting and repelling the mask 100. Thus, the magnetic or electromagnetic field (e.g., from electromagnet 116 in FIG. 1B) and ferromagnetic plating cooperate to securely hold the mask 100 in place and reduce mask deformation and/or vibrations. Once screening is complete, the dampener (e.g., 118), if included, further reduces mask vibrations post screening and also reduces mask-vibration induced fatigue.

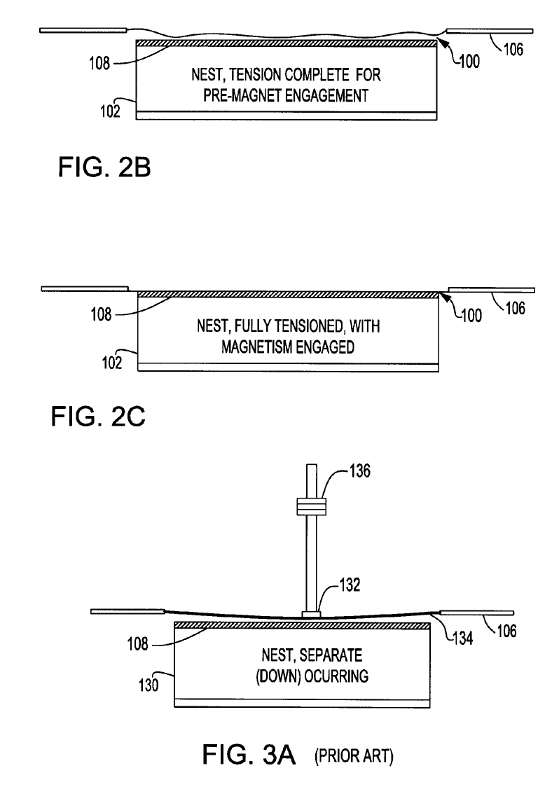

FIGS. 3A-C show a prior art dampened nest 130 with a mechanical dampener 132 disposed on a mask 134 as compared with two alternate preferred embodiment mechanical dampened nests 102′, 102″ according to the present invention with reference to the examples of FIGS. 1A and 2A-C. So, in the prior art example of FIG. 3A, a weight stack 136 on the mechanical dampener 132 applies a downward force to the mask 134 to dampen vibrations from raising the prior art nest 130 to tension the mask 134 and from lowering the nest 130 to release that tension. However, if the dampening weight 136 is too heavy, it stretches the mask 130; if it is too light, it provides very little dampening. By contrast however, the centered-buried electromagnetic dampener 118 of FIG. 3B only applies force when it is active, i.e., clamping the mask 100 when the nest 102′ is being lowered. Similarly, the top-centered electromagnetic dampener 118′ of FIG. 3C adds little weight to the mask 100′, but with power being supplied 137 to activate it during separation, the magnetic force actively pushes the mask 100′ up and away from the green sheet 108 during separation and assists in clamping when the nest is up. Further, by slidably locating the top-centered electromagnetic dampener 118′ on the center post 138, it may be raised and lowered on the post 138 as desired for an optimized dampening position.

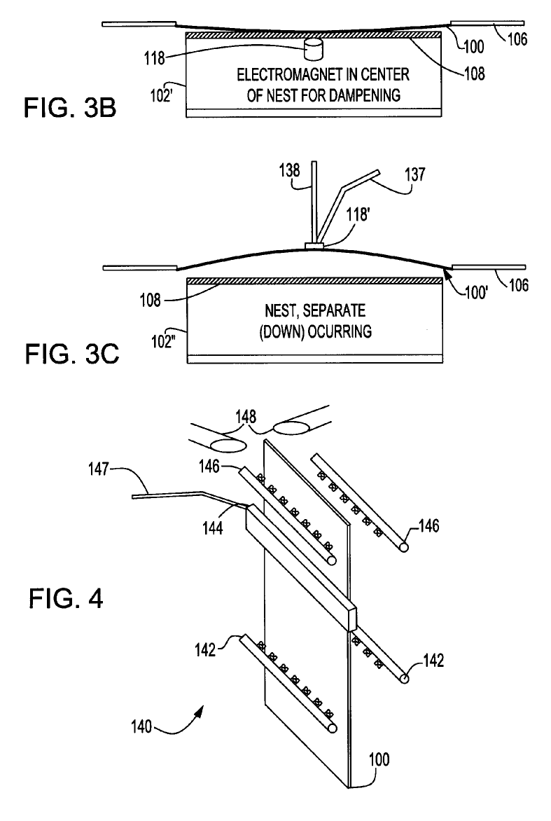

FIG. 4 shows an example of a mask cleaning station 140 according to a preferred embodiment of the present invention. The mask 100 passes vertically though the cleaning station 140, from up to down in this example. High-pressure cleaner dispensers 142 direct TMAH at either side of the mask 100. An electromagnet 144 is fixed at one side just below rinse dispensers 146 and is activated through electrical connection 147. Preferably the rinse dispensers direct clean de-ionized water on the mask 100. Finally, a blower 148 above the rinse dispensers 146 blows hot air on the cleaned mask 100 to dry it. Thus, activating the electromagnet 146 during the cleaning, in particular during the high-pressure air dry, dramatically reduces mask vibrations that would otherwise occur. Since these vibrations can cause mask fatigue and break flexing mask features (tabs), thereby, making the mask 100 unusable; decreasing or eliminating mask vibrations (by magnetically immobilizing the mask during cleaning) reduces mask fatigue and extends mask life.

Advantageously, since a preferred embodiment mask is magnetically clamped to the green sheet during screening, the mask pattern is more faithfully screened onto the green sheet. Further, since magnetically clamping the mask to the green sheet virtually eliminates any gap between the mask and the green sheet, the paste cannot bleed out to avoid associated bleed out defects, frequently found in final prior art product. Further, mask life is extended because mask vibrations are minimized before and after screening, which minimizes associated mask fatigue and damages it, i.e., breaking tabs. Thus, associated defects to the screened pattern are minimized as well. Additionally, mask life is further extended because mask vibrations are minimized during cleaning where mask fatigue and damage (i.e., from broken tabs), has plagued prior art masks and mask cleaning procedures.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A screening nest for holding a non-conductive layer having a pattern screened thereon, said screening nest comprising:
a nest top;
at least one up location on said nest top;
a nest bottom assembly, said nest top being attached to said nest bottom assembly; and
an electromagnet disposed in said nest bottom assembly, whereby a mask of a magnetic material on a non-conductive layer placed on said nest top is magnetically clamped to said non-conductive layer in said at least one up location.

2. A screening nest as in claim 1, wherein at least one said up location is one up location and said electromagnet is formed in a pattern matching a configuration of said one up location.

3. A screening nest as in claim 1, wherein at least one said up location is four up locations and said electromagnet is formed in a pattern matching a configuration of said four up locations.

4. A screening nest as in claim 1, further comprising a dampening electromagnet in said bottom nest assembly, said dampening electromagnet selectively dampening mask vibrations from raising and lowering said nest to and from a mask disposed above said nest.

5. A screening nest as in claim 4, wherein said dampening electromagnet is disposed in the center of said bottom nest assembly.

6. A screening nest as in claim 1, wherein said at least one up location is an up location for a ceramic green sheet.

7. A cleaning arrangement for cleaning a mask for screening a pattern on a non-conductive layer, said cleaning arrangement comprising:
a cleaning solution dispenser spraying cleaning solutions on both sides of a mask being cleaned;
an electromagnet disposed above said cleaning solution dispenser, said electromagnet dampening vibrations in said mask being cleaned; and
a rinse dispenser disposed above said electromagnet, vibrations from rinsing said mask being magnetically dampened.

8. A cleaning arrangement as in claim 7, wherein said cleaning solution dispenser sprays Tetra-Methyl Ammonium Hydroxide (TMAH) on both sides of said mask.

9. A cleaning arrangement as in claim 7, wherein said rinse dispenser sprays de-ionized water on both sides of said mask.

10. A cleaning arrangement as in claim 7, wherein said cleaning arrangement further comprises:
a dryer disposed above said rinse dispenser directing air at both sides of said mask, vibrations from said dryer being magnetically dampened during drying.

11. A cleaning arrangement as in claim 7, wherein said mask is a mask for screening a conductive paste on a ceramic green sheet.

12. A method of screening patterns on an uncured ceramic layer, said method comprising the steps of:
a) placing a ceramic green sheet on a nest;
b) disposing a mask above said nest;
c) raising said nest to said mask;
d) magnetically clamping said mask to said nest, said mask being magnetically clamped to a surface of said green sheet; and
e) applying paste to said mask.

13. A method of screening patterns on a ceramic green sheet as in claim 12, further comprising the step of:
f) lowering said nest, a conductive pattern remaining on said green sheet, said mask being magnetically dampened while said nest is being lowered.

14. A method of screening patterns on a ceramic green sheet as in claim 13, wherein said mask is magnetically dampened from below said green sheet.

15. A method of screening patterns on a ceramic green sheet as in claim 13, wherein said mask is magnetically dampened from above said mask.

16. A method of screening patterns on a number of green sheets as in claim 13, said method further comprising the steps of:
g) repeating steps (a)-(f) until a number of green sheets have been screened; and
h) cleaning said mask and returning to step (a).

17. A method of screening patterns on a number of green sheets as in claim 16, wherein cleaning said mask in step (h) comprises the steps of:
i) spraying said mask with a Tetra-Methyl Ammonium Hydroxide (TMAH) solution;
ii) rinsing said mask with water; and
iii) drying said mask with pressurized air, said mask being magnetically dampened at least during said rinsing step (ii) and said drying step (iii).

18. A method of screening patterns on a number of green sheets as in claim 13, said method further comprising the steps of:
g) spraying said mask with a Tetra-Methyl Ammonium Hydroxide (TMAH) solution;
h) rinsing said mask with water;
i) drying said mask with pressurized air, said mask being magnetically dampened at least during said rinsing step (h) and said drying step (i); and
j) returning to step (a).
